(19) United States
(12) Patent Application Publication
(10) Pub. No.: US 2014/0282358 A1
(43) Pub. Date: Sep. 18, 2014

(54) Software Product Capable of Using Zero and Third Party Applications

(71) Applicant: MICROSOFT CORPORATION, Redmond, WA (US)

(72) Inventors: David Mowatt, Dublin (IE); Terry Farrell, Dublin (IE)

(73) Assignee: MICROSOFT CORPORATION, Redmond, WA (US)

(21) Appl. No.: 13/833,300

(22) Filed: Mar. 15, 2013

(51) Int. Cl. G06F 9/44

(52) U.S. Cl. CPC G06F 8/70
USPC 717/104

(57) ABSTRACT

A software product with an integrated application platform can provide functionality for modifying, adding, or removing features of a software product through the use of applications that are integrated into the software product. A software product with an integrated application platform can also provide for the ability of a third party to modify the features of a generic version of a software product to create a custom software product. The developer of the software product can identify features of the software product that are modifiable and/or extendable. When a user selects one or more features to be modified, the features to be modified can be checked against a feature list to see if the features are modifiable. If the features are modifiable, the software product can invoke a search mechanism to allow a user to search various sources for applications that are usable within the software product.

### BACKGROUND

Some software products can have a large breadth to the capabilities they offer. A software product can have a significant number of features that can be implemented by a user of the software product. Often the software product is licensed with a wide-ranging number of features that the developer of the software product has added over-time to satisfy the needs of multiple classes of user, rather than targeting just one specific class of user. Some software products can have such a large number of features that the use of the features can be confusing for any one given user. Because of this, it is not unusual for a given user to have little or no need for particular features of a conventional software product. A user may not know about the features, how to access the features, or how to use the features. A user will frequently utilize only those features commonly known and easily accessible, reducing the ability of a given user to take full advantage and optimal usability of capabilities of the software product.

Software products are often deployed as locked software products. Locked software products are products that permit only minimal customization of the software product, if at all. Some software products are locked because of perceived security concerns. Some are locked so that help documentation with screenshots can always match the user interface as every user sees it. The developer may determine that allowing a user to customize or modify the software product can introduce security flaws into a system, reducing the integrity of the system and increasing the risk of a security attack. Some software products are locked because the developer has determined that introducing customization by the user of the software product may reduce the integrity of the software product, and possibly, the stability of the system executing the software product. For these and other reasons, it is often difficult for the user to customize the software product to suit their particular needs.

Additionally, because of the constraints placed on typical software products, it can be difficult for software developers to create software for use in vertical industries. A large number of software products are deployed without software development kits (SDK). Software development kits are software development tools for a specific software product that a developer can use to create applications for the software product. These SDKs can come in various forms such as an application programming interface (API), but can also include debugging aids and other utilities in an integrated development environment.

It is with respect to these and other considerations that the disclosure made herein is presented.

### SUMMARY

Concepts and technologies are described herein for a software product having an application platform integrated into the software product. In accordance with some concepts and technologies disclosed herein, the application platform can allow a user to modify various features within a software product. A software product with an application platform can allow a user to remove features, integrate applications into the software product to replace currently installed features, or add features not installed in the software product. In further implementations of the present disclosure, the application platform may allow a user to customize the software product.

According to one aspect disclosed herein, a software product having an application platform may allow a third party, such as a developer or value added reseller, to create a custom software product using an original software product as a core product upon which the custom software product is built. A third party may create a custom software product by removing some features of an original software product and replace those features with custom features provided by custom applications. In some configurations, the third party may then sell the custom software product, which can be a repackaged version of the original software product.

According to another aspect disclosed herein, a user may be able to select one or more features of a software product, receive information about whether or not the features can be modified, and/or modify features using an application platform integrated with the software product. The application platform may include one or more applications that integrate into the software product to extend or replace functionality provided by the software product.

In some implementations, the application platform may include applications developed and provided by the developer of the software product (referred to herein as “zero party applications”), applications developed by third-parties (referred to herein as “third party applications”), and/or combinations thereof. In other cases, the developer may include applications which are not bundled into the software product, often called “first party applications,” which from an implementation perspective are typically treated in a manner similar to third party applications.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the concepts and technologies disclosed herein, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a system diagram showing one mechanism disclosed herein for providing a software product integrated with an application platform, according to one embodiment disclosed herein.

FIG. 1B is a system diagram showing a mechanism disclosed herein for providing a custom software product using an application platform, according to one embodiment disclosed herein.

FIG. 2A is a user interface (“UI”) diagram showing one illustrative UI provided by a software product configured for use with an application platform, in accordance with some embodiments.

FIG. 2B is a UI diagram showing a search UI provided by a software product configured for use with an application platform, in accordance with some embodiments.

FIG. 3 is a UI diagram showing one user interface provided by a software product that illustrates the integration of modified features into the software product using a software product integrated with an application platform, in accordance with some embodiments.

FIG. 4 is a UI diagram showing one UI that illustrates aspects of the replacement and integration of modified features in a software product integrated with an application platform, in accordance with some embodiments.

FIG. 5 is a flow diagram showing one illustrative routine for developing a software product having an application platform, in accordance with some embodiments.

FIG. 6 is a flow diagram showing one illustrative routine for providing a software product integrated with an application platform, in accordance with some embodiments.

FIG. 7 is a flow diagram showing one illustrative routine for integrating a feature provided by an application into a software product integrated with an application platform, in accordance with some embodiments.

FIG. 8 is a computer architecture diagram showing one illustrative computer hardware and software architecture for a computing system capable of implementing aspects of the embodiments presented herein.

FIG. 9 is a computer system and network diagram illustrating a distributed computing environment capable of implementing aspects of the embodiments presented herein.

FIG. 10 is a computer architecture diagram illustrating a computing device architecture capable of implementing aspects of the embodiments presented herein.

### DETAILED DESCRIPTION

The following detailed description is directed to software product with the ability to use an application platform integrated into the software product. In some configurations, the application platform can be a combination of one or more services that provide the ability to modify various features associated with a software product using applications from an application data store. A user may be able to select one or more features, receive information about whether or not the features can be modified, and then modify the features using the application platform. The application platform may provide for the ability to search for one or more applications for use within the software product. The application platform may provide for the ability to integrate into the software product zero party applications developed and provided by the developer of the software product, third party applications developed by third-parties, and/or combinations thereof. The application platform may allow a developer or third party to customize a software product to create a custom software product for resell.

In some configurations, access to various features of the software product may be limited depending on the developer of the application. For example, applications developed by a trusted entity, such as the developer of the software product or a verified entity, may be provided with permission to modify critical operating environment resources such as disk, a registry, and the like. In a similar manner, applications developed by an unverified entity may be provided with permission to only modify or access to higher level, non-critical system functions. In some implementations, the software product may be configured to identify the developer of an application to be integrated into the software product in order to determine the permission level for an application. In other implementations, the software product may be configured to receive a certificate from an application store from which the application was received to determine the level of access permitted by the application.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodologies for providing a software product with an integrated application platform, and other aspects will be presented.

Referring now to FIG. 1A, a system diagram showing one mechanism disclosed herein for providing an integrated software product-application platform will be described. The mechanism shown in FIG. 1A includes a computing device 100 operating in communication with a network 102. It should be appreciated that the concepts and technologies described herein are not limited to requiring that the computing device 100 to be in communication with the network 102, as various aspects described herein may be implemented on the computing device 100 without the network 102. Further, the concepts and technologies described herein are not limited to any particular type of networking implementation for the network 102. In some configurations, the network 102 is the Internet, an intranet, an extranet, or various combinations thereof. In some configurations, the computing device 100 is a desktop computer, a laptop computer, a notebook computer, an ultra-portable computer, a netbook computer, or a computing device such as a “smart” mobile telephone, a tablet device, a slate device, a portable video game device, or the like. In this regard, it should generally be appreciated that the hardware components, including the computing device 100 and the network 102, are merely illustrative and that the embodiments described herein might be implemented using other types of hardware devices.

In one implementation, the computing device 100 executes an operating system 104. The operating system 104 is an executable program for controlling various functions of the computing device 100. The computing device 100 can also execute a software product 106. In some embodiments, the software product 106 may include, but is not limited to, one or more productivity application programs that are part of the MICROSOFT OFFICE family of products from MICROSOFT CORPORATION in Redmond, Wash. Examples of such application programs include, but are not limited to, MICROSOFT WORD, MICROSOFT EXCEL, MICROSOFT POWERPOINT, MICROSOFT SHAREPOINT, MICROSOFT ACCESS, MICROSOFT VISIO, or MICROSOFT OUTLOOK. In some embodiments, the software product 106 may include, but is not limited to, one or more productivity application programs that are part of the GOOGLE DOCS or GOOGLE SITES family of products from GOOGLE, INC. in Mountain View, Calif. The software product 106 might also be an application of another type from another vendor in other embodiments.

As described briefly above, when using the software product 106, a user (not shown) may want to modify the features 108 by adding a feature, removing a feature or changing a feature. As used herein, a “feature” can mean a function, task, or operation performed or executed at least in part by the software product 106. Examples of features may vary depending on the particular use of the software product 106. For example, a word processing software product may have features such as grammar check, spell check, formatting, marked up review, insertion of references, and the like. In another example, a drawing software product may have features such as pictures, diagramming, spell check, layout, and others. It should be understood that the concepts and technologies described herein are not limited to any particular software product feature.

When using the software product 106, a user may want to configure the software product 106 to the user's particular needs or preferences. For example, when using a word processing program, a user may want to use a specialized grammar check feature used in a particular industry not currently offered in the software product 106. A specialized grammar check feature may check for certain words, phrases, and/or punctuation that a user may need to utilize the software product 106 in a desired way. For example, a patent grammar check feature may be different to a general grammar check feature.

In accordance with various embodiments of the disclosure provided herein, in order to allow for the modification of the software product 106, the software product 106 can be configured to allow the integration of an application 110 into the software product 106. As discussed briefly above, the application 110 can be used to extend the software product 106 by providing one or more features not currently provided by the software product 106. The application 110 can also be used to change one or more of the features 108 currently provided by the software product. In another implementation, the application 110 can extend one or more features of the software product 106 by adding additional functionality not present in the software product 106. The presently disclosed subject matter is not limited to any particular benefit the application 110 may provide to a user or the software product 106.

The application 110 can be integrated into the software product 106 using functionality provided by an application platform 111. The application platform 111 can provide functionality that facilitates the consumption of the application 110 by the software product 106. Integration capabilities of the software product 106 to use the application platform 111 can be part of an SDK provided to developers. The application platform 111 can be a combination of the services or products provided one or more components of the software product 106, the computing device 110, and/or remote components, described in further detail below. It should be understood that the inclusion or exclusion of one or more components does not limit the scope of the present disclosure to the included or excluded component. The functionality provided by the application platform 111 is merely illustrative and is provided for descriptive purposes only.

An exemplary function provided by the application platform 111 may be to provide a user with the ability to select one or more of the features 110 to be modified subject to modification limitations of the software product 106. For example, the software product 106 may be configured by a developer of the software product 106 to limit the ability of a user to modify certain features of the software product 106. In another example, an enterprise may configure the software product 106 according to an enterprise-wide policy to limit the modification of certain features 110. As discussed above, the modification of some of the features 108 of the software product 106 may introduce security flaws into the computing device 100 or may reduce the stability of the software product 106.

To integrate the application 110 into the software product 106, the software product 106 may have an application integrator 112. The application integrator 112 can be configured to process feature modifications. The feature modifications can be requested by, for example, but not by way of limitation, a user, another entity, or the software product 106. The application integrator 112 can be part of the software product 106, may be a standalone software product, or may be integrated into another software product used by the software product 106. The concepts and technologies described herein are not limited to any particular implementation of the application integrator 112. In one configuration, the application integrator 112 can perform various application integration functions such as determining a status of a particular feature from a feature list 114.

The feature list 114 can identify features of the software product 106. The feature list 114 can also identify one or more features of the software product 106 that can be modified by the application 110. The feature list 114 may also identify one or more features that cannot be modified by the application 110. As mentioned above, the modification of a feature can be through the addition of the feature to the software product 106, the change of a currently installed feature of the software product 106, the removal of a currently installed feature of the software product 106, or the extension of a currently installed feature with additional capabilities. However, it should be appreciated that the features may be modified in other respects not specifically delineated herein, and are considered to be within the scope of the presently disclosed subject matter.

If a feature can be modified, the application integrator 112 can invoke an application searcher 116 to search for one or more applications that may meet search criteria based on the modification. It should be understood that the present disclosure is not limited to requiring a search be performed, as capabilities may be added without an explicit search. For example, features may be automatically integrated based on other features integrated into the software product 106. In another example, the software product 106 may be automatically upgraded based on the use of a particular feature. In another example, the feature may be associated with a certain class of features. In that example, a user may be able to select the feature from a list rather than inputting a query. These and other configurations are considered to be within the scope of the present disclosure.

The search criteria can be provided by various sources such as a user of the software product 106. The search criteria may include what the user types, a feature category, language support, the software product 106 that the feature works with, a list of features the user already owns, the ratings that the user has given to other features they have, and others. The search criteria can also be provided by the software product 106. For example, a user may select a feature to be modified. The software application 106 may be configured to receive the selection input and form a search criteria based on the input. The disclosure provided herein is not limited to any particular search criteria, examples of which are provided in FIG. 2B, below.

The application searcher 116 may communicate with one or more application data stores to search for and retrieve one or more applications that may meet the criteria. The application data stores may be repositories of applications capable of being accessed and searched. In one configuration, the application data store may be a zero party application store 120. As used herein, “zero party” means an entity that develops the software product 106 and/or is a trusted entity. A zero party application store 120 is, therefore, an electronic store through which applications, provided by the developer of the software product 106 and/or another type of trusted entity, may be obtained for use with the software product 106. In some configurations, the applications in the zero party application store 120 can be updated or serviced independently of the software product 106 using the infrastructure provided by the zero party application store 120 even though applications in the zero party store 120 may be provided by the developer of the software product 106 or another type of trusted entity.

In another implementation, the application data store may be a third party application store 118. A third party application store is an electronic store through which applications, provided by an entity other than the developer of the software product 106, may be obtained for use with the software product 106. As will be described in greater detail below, the access level of system resources allowed for certain applications may depend upon the source of the application. Thus, in some configurations, a zero party may be considered a trusted entity whose applications may have unrestricted system resource permission levels. Applications provided by a third party might be provided a lower level of trust. These applications might be restricted in the manner in which they can access resources of the computing device 100.

Although FIG. 1A illustrates that the third party application store 118 and the zero party application store 120 are accessed through the network 102, it should be understood that the concepts and technologies described herein are not limited to an application data store separate from any particular component of the computing device 100. For example, the application searcher 116 might be configured to search for one or more applications on various storage devices associated with the computing device 100, such as a local application data store 122. In another example, the application searcher 116 may be configured to search for one or more applications stored in the files of the software product 106. In this example, the software product 106 may be configured to have several features (or applications) that are provided in the installed files of the software product 106 but, for various reasons, are not enabled for use with the software product until they are activated by a user or other entity.

As mentioned briefly above, the third party application store 118 and the zero party application store 120 can be application data stores provided by one or more entities. For example, the third party application store 118 and/or the zero party application store 120 can be the ITUNES store provided by APPLE, INC. of Cupertino, Calif. In another example, the third party application store 118 and/or the zero party application store 120 can be the GOOGLE PLAY store provided by GOOGLE, INC. of Mountain View, Calif.

Although not limited in such a way, in one configuration, the zero party application store 120 can be an application data store provided by the developer of the software product 106. For example, if the software product 106 is MICROSOFT WORD, the zero party application store 120 can be hosted by, supported by, or provided by MICROSOFT CORPORATION. In another configuration, the third party application store 118 can be an application store provided by an entity designated as a third party. It should be appreciated that the concepts and technologies described herein are not limited to any particular application store configuration, as one application store may provide various types of applications and be configured in various ways.

The third party application store 118 and/or the zero party application store 120 can return search results to the application searcher 116. The results can be presented to the requesting entity, such as the user or the software product 106, which may select which application to integrate. In some examples, additional information may be presented to assist with the selection. The additional information may include, but is not limited to, descriptions of the application, reviews of the application, and others. The requesting entity may then select the particular application for integration into the software product 106.

Once selected, the application integrator 112 can modify the files of the software product 106 to integrate the selected application into the features 108 of the software product 106 for use. It should be appreciated that the concepts and technologies described herein are not limited to any particular mode or manner of integration. For example, the software product 106 may be configured with a plug-and-play type of environment in which the software product 106 may be preconfigured to receive the app. In another example, the application integrator 112 may be configured to add to or replace pre-existing features 108 whose functions are subsumed by the application to be integrated into the software product 106.

The ability to integrate the selected application into the features 108 of the software product 106 can provide various benefits, including the customization of the software product 106. For instance, a value added reseller may have expertise in a certain industry such as the law, dentistry, or horticulture and may want to sell a software product capable of serving the needs of consumers in that specialized market. But, the market for the specific industry may not be large enough to warrant the development of a software product capable of serving the needs of the particular industry. In accordance with various aspects of the present disclosure, a value added reseller may be able to service the particular industry by customizing the software product 106 by removing some of the features 108, which may be generic, and augment the software product 106 with customized features provided by one or more applications specifically tailored to the particular industry.

FIG. 1B is a system diagram showing a mechanism that can allow third parties to create custom software products using an integrated software product-application platform. A value added reseller 124 may want to create a custom software product 106A for sale in a specialized marketplace. The custom software product 106A may be a customized version of the software product 106. The custom software product 106A may use core functionality of the software product 106, but may be customized to provide custom features 108A using custom applications 110A. In order to do so, the value added reseller 124 may search application data stores such as the zero party application store 120 and/or the third party application store 118 for one or more custom applications 110A that provide the custom features 108A. In some implementations, the value added reseller 124 may be the developer and source of the custom applications 110A. The concepts and technologies described herein are not limited to any particular source of the applications 110A.

By creating the custom software product 106, the core functionality of the software product 106 can be provided to multiple industries in the form of the custom software product 106A, some of which may not otherwise be served. It may not be economically feasible for a developer to develop multiple versions of the same software product with each having industry-specific features. Integrating an application platform 111 into the software product may allow the developer of the software product 106 to reach a broader range of customers by allowing the software product 106 to be customized for a particular industry, and then resold as the custom software product 106A in that industry. This can allow for a wider adoption of the software product 106 in certain industries that have needs that are too specialized for the software product 106 to compete against other software products. Unique marketing opportunities may be presented in the specialized industries.

The expertise added by the third party may help create additional goodwill in the particular industry because the custom software product 106A has been associated with custom features 108A denoting an expertise in the particular industry. This goodwill may be used as an opportunity to market and brand the software product by associating a custom brand. The custom brand may be logo or symbol used to denote the customization of the product and to differentiate the custom software product 106A from generic software products, such as the software product 106. The custom brand may be used to market the custom software product 106A in verticals possibly not achievable through the distribution of the software product 106 without the custom features 108A. For example, the opening splash screen when the software product is executed may have a custom brand indicating that the custom software product 106A is a specifically tailored application built onto a core software product, such as the software product 106.

The custom product 106A may also be configured to provide targeted assistance to users in the form of custom help 126. The custom help 126 can be configured to provide users with not only general help advice, but also, provide advice geared toward the custom features 108A integrated into the custom software product 106A. The level or type of customization to the software product 106 may be controlled by the software product 106. For example, a manifest file associated with the software product 106 may provide input regarding the types of customizations that may be available or allowable for the software product 106.

The customization may also provide for additional value. For example, the custom software product 106A may also be provided with a set of custom templates 128. The custom templates 128 may be add-ons that are geared towards use within the custom software product 106A. The custom templates 128 may be part of the tailored product or may be purchased separately in the zero party application store 120 or the third party application store 118. The use or demonstration of the custom templates 128 may show a user in a particular industry the level of customization and depths of capabilities built into the custom software product.

The expertise of a third party may also be showcased by providing user experiences unique to the custom software product 106A. Outputs created by the custom software product 108A may have metadata associated with the output. The metadata may be used by the software product 106 to inform a user that the output has data associated with it that may provide a different user experience if the output is used with a software product configured with similar capabilities as the custom software product 106A. For example, a document created in the custom software product 106A may be viewable using the software product 106. But, the document may have metadata associated with the document that informs a user that the document may be better viewed in the custom software product 106A. The expertise of the value added reseller and the developer of the original software product may be integrated and showcased in various ways. FIGS. 2-4 provide some examples of UIs that may be used to integrate features into a software product.

FIG. 2A is a UI diagram showing one illustrative UI 200 provided by a software product 106 configured for use with an application platform, in accordance with some embodiments. In the example shown in FIG. 2A, the software product 106 is a word processing program that provides the features 108. The features 108 can be selected for use by the selection of a tab in a ribbon 202. By way of example, a tab 202A of the ribbon 202 can be selected to cause the software product 106 to execute an “INSERT” feature. Some tabs of the ribbon 202, when selected, can present additional tabs in a ribbon 204. For example, if the tab 202B, corresponding to a “REVIEW” feature, is selected, the ribbon 204 can be displayed. For example, the ribbon 204 can include tab 204A that, when selected, causes the software product 106 to execute a “SPELLING AND GRAMMAR” feature. In a similar manner, the ribbon 204 can include tab 204B that, when selected, causes the software product 106 to execute a “LANGUAGE” feature. In another example, the ribbon 204 can include tab 204C that, when selected, causes the software product 106 to execute a “COMPARE” feature. Still further, the ribbon 204 can include a tab 204D that, when selected, causes the software product 106 to execute a “PROTECT” feature. The concepts and technologies described herein are not limited to any particular mechanism for selecting the execution of the features 108.

Various implementations of the presently disclosed subject matter can allow the modification of a feature to the software product. The modification of one or more features executed upon selection of a tab of the ribbon 202 or 204 may be because of a requirement or configuration desired by a user or other requesting entity. In another configuration, the modification may be as a result of a package of features provided by another entity, such as a bundling of applications into a group of applications for license. For example, a company may have a specialization in a particular industry. The specialization may be to provide features in application form to be integrated into software products to perform various tasks. The concepts and technologies described herein are not limited to any particular source or reason for the modification, addition or removal of any feature.

In one configuration, to provide for modification of one or more of the features 108, the UI 200 may be configured to provide an application searcher initiation button 206. When the application searcher initiation button 206 receives an input, such as the selection of the application searcher initiation button 206 by a user (not shown), the application searcher 116 of FIG. 1A is invoked. In one configuration, when the application searcher initiation button 206 receives an input, one or more search UIs may be presented to provide input to the application searcher 116, as illustrated by way of example in FIG. 2B. The term search is used in a broad sense and may or may not involve explicit human input, for example, in one implementation a drop down list may appear by the button for the original feature that executes a background query for items of a similar category to that feature.

FIG. 2B is a UI diagram showing the UI 200 upon the receipt of an input to the application searcher initiation button 206. Illustrated in FIG. 2B is feature search selection UI 208, which may be presented upon the receipt of an input to the application searcher initiation button 206. The feature search selection UI 208 may an area in which an input may be received to search for a particular feature 108 to be provided by an application. Illustrated in the feature search selection UI 208 is selection list 210, which correlates to features 108 that are modifiable. In some implementations, there may be features 108 that may not be modifiable. In this configuration, the feature search selection UI can include prohibited list 212, which correspond to features that are not modifiable. The feature search UI 108 may also include a text input interface 214. A user can input text into the text input interface 214. The text can be search terms, keywords, or other variables that the application searcher 116 can use to search. It should be understood that the present disclosure is not limited to text-based inquiries, as other searching techniques may be used. For example, some implementations may use category-based browsing, in which the searching entity can perform a manual search operation by browsing through various categories.

Once the feature 108 is selected for search and/or text is entered into the text input interface 214, the application searcher 116 can execute a search in one or more application stores that may provide the feature, an implementation of which is provided by way of example in FIG. 1A, above. The results of the search can be displayed in search results UI 216. The search results UI 216 can include the search results 218. The search results 218 can include one or more applications that provide the feature selected for modification. The search results 218 can also include additional information such as descriptions or reviews of one or more of the results in the search results 218. An application in the search results 218 can be selected, which causes the application integrator 112 to integrate the selected application into the software product 106. It should be appreciated that the concepts and technologies described herein are not limited to the use of the feature search selection UI 208 or the text input interface 214, as other technologies for searching, including other types of search UIs may be used in accordance with the concepts and technologies described herein. Further, it should be understood that various implementations of the disclosure provided herein do not require that the selected application be retrieved through a search function.

Once one or more features have been searched and selected for integration, the UI 200 can be modified to indicate the integration of the new features. FIG. 3 illustrates an implementation of the UI 200 showing how the ribbon 204 cab be modified based on the selection of a one or more applications for integration. In the example illustrated in FIG. 3, the features associated with the tabs 204A, 204B and 204C of FIG. 2A have been modified, illustrated as now being highlighted in black to signify that the features associated with those tabs have been modified. The concepts and technologies described herein are not limited to any particular manner of indicating which features have been modified. Further, it should be appreciated that the concepts and technologies described herein are not limited to any requirement that the appearance of any modified, removed or added features be changed. A feature may be modified without any change to the appearance of the input used to execute the feature.

FIG. 4 is the UI 200 after the modification illustrated in FIG. 3, above, along with a change in the features provided. Illustrated in FIG. 4 are the modified versions of the tabs 204A, 204B, and 204C (illustrated as shaded). As described above, various configurations of the concepts and technologies described herein may provide for the ability to not only modify various features, but to remove and add new features as well. In FIG. 4, tab 204D corresponding to the feature “PROTECT” illustrated in the UI 200 of FIG. 2A, has been replaced by a tab 204E, which now corresponds to the feature “UPDATE.” It should be appreciated that the concepts and technologies described herein are not limited to requiring that a removed feature be replaced, as some configurations may provide for a feature to be removed without necessitating its replacement by another feature.

Turning now to FIG. 5, aspects of a routine 500 for providing an integrated software product-application platform are illustrated, according to an illustrative embodiment. Various implementations of the routine 500 may be used by a developer of the software product 106 to provide for the application platform 111. In some configurations, the developer may want to establish certain criteria in which applications may be integrated into the software product 106. One of those criteria may be the features that can be modified. Although the software product 106 may be changed after distribution to provide for an application platform 111, it may be beneficial to configure the software product 106 to include such functionality prior to its release.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims. It also should be understood that the illustrated methods can be ended at any time and need not be performed in its entirety.

Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. The operations of the methods are described herein below as being implemented, at least in part, by the software product 106, application searcher 116, application integrator 112, or combinations thereof. One or more of the operations of the routine 500, and the other operations described herein, may alternatively or additionally be implemented, at least in part, by other similarly configured components in the computing device 100, even if not specifically designated in the figures.

The routine 500 begins at operation 502, where data is stored identifying features 108 provided by the software product 106. To provide for the application platform 111, a developer of the software product 106 may want to allow the ability to modify one or more of the features 108. It should be appreciated that the concepts and technologies are not limited to requiring the software product 106 to be configured to have features that can be modified when deploying the software product 106. For example, the software product 106 may be configured to have various capabilities described herein but, for various reasons, the capabilities may not be accessible to a user. In one implementation, a user may be presented with a “free” version of the software product 106. The free version may not be configurable by the user but may have the capability of being configured if permission is granted by an entity such as the software developer when a user pays for a license to use the product.

As mentioned above, during development, the features provided by the software product 106 may be listed in one or more data stores. From operation 502, the routine 500 proceeds to operation 504, where a first feature provided by the software product 106 is retrieved. From operation 504, the routine 500 proceeds to operation 506 where a determination is made as to whether or not the feature retrieved in operation 504 is modifiable. There may be various reasons the feature may not be modifiable. For example, and not by way of limitation, the feature may be a core feature that, if changed, may remove critical functionality of the software product 106. In another example, the feature may be a feature that regularly access critical system resources that, if changed, may hinder the operation of the computing device 100. The concepts and technologies described herein are not limited to any particular reason the feature may be modifiable.

If at operation 506 the feature is determined to not be modifiable, the routine 500 proceeds from operation 506 to operation 508, where the feature is added to the feature list 114 as being non-modifiable. Thus, in some configurations, attempts to modify the feature would be prevented. From operation 508, the routine 500 proceeds to operation 510, where a determination is made as to whether or not there are additional features to be designated as modifiable or non-modifiable in the feature list 114. If there are additional features, the routine 500 proceeds to operation 504 and continues until there are no additional features, whereby the routine 500 proceeds to end.

If at operation 506 the feature is determined to be modifiable, the routine 500 proceeds from operation 506 to operation 512, where the feature is added to the feature list 114 as being modifiable. Thus, in some configurations, a user or other entity can change, add or remove the feature. Although the concepts and technologies described herein are not limited to any particular reason, various features may be designated as modifiable for various reasons. For example, a feature may be a feature that has been known to be modified in prior implementations of the software product 106. In another example, the feature may be a new feature not implemented by configured for use by a user if the user so desires. From operation 512, the routine 500 proceeds to operation 510, where a determination is made as to whether or not there are additional features to be designated as modifiable or non-modifiable in the feature list 114. If there are additional features, the routine 500 proceeds to operation 504 and continues until there are no additional features, whereby the routine 500 proceeds to end.

FIG. 6 illustrates aspects of a routine 600 for integrating an application searcher function into the software product 106. The routine 600 begins at operation 602, where an input is received to invoke the application searcher 116 to search for a feature to be modified. As used herein, modified means to change, add or remove. The input may be received using various technologies, including the application searcher initiation button 206. Other concepts and technologies may be implemented and are considered to be within the scope of the present disclosure. For example, the software product 106 may detect various user interactions with the software product 106 that may be better served with an application. In that configuration, the software product 106, itself, may generate the input to invoke the application searcher 116.

From operation 602, the routine 600 proceeds to operation 604, where a determination is made if the feature is in the feature list 114. Although not limited to any particular reason, a feature may not be included in the feature list 114 for various reasons. For example, the feature list 114 may include only features that are modifiable. In another example, the feature list 114 may include modifiable and non-modifiable features, but designate the features as being one or the other for use by the application searcher 116. If the feature is not in the feature list, but the software developer has configured the software product 106 with features to be modified, the routine 600 can proceed from operation 604 to operation 608, where a determination is made as to whether or not the feature can be modified. As previously mentioned, some features that can be added to the software product 106 may be not be listed as one of the features in the feature list 114. If the feature is not modifiable, the routine 600 ends. If the feature is modifiable, the routine 600 proceeds from operation 608 to operation 612, where the application searcher 116 can be invoked to search one or more stores, such as the third party application store 118 and/or the zero party application store 120 based on search criteria received.

From operation 612, the routine 600 proceeds to operation 614, where a determination is made as to whether or not one or more applications providing the searched-for feature are found as a result of the search. If one or more applications are found, the routine 600 proceeds from operation 614 to operation 616, where the application may be integrated into the software product 106. If there are no applications found, or the applications found are not selected for integration, the routine 600 ends.

If at operation 604 the feature to be modified is determined to be in the feature list 114, the routine 600 proceeds from operation 604 to operation 606, where a determination is made as to whether or not the feature is modifiable. If the feature is not modifiable, the routine 600 ends. If the feature is determined to be modifiable, the routine 600 proceeds from operation 606 to operation 612, where the application searcher 116 can be invoked to search one or more stores, such as the third party application store 118 and/or the zero party application store 120 based on search criteria received.

In some configurations, the ability of the application to be integrated, as well as the system resource access levels, may depend on the developer of the application. For example, the developer of the software product 106 may determine that one or more developers can develop applications that can access sensitive or critical system resources of the computing device 100. In another example, the developer of the application 110 may be the developer of the software product 106. In that example, the level of access to system resources of the computing device 100 can be at a high level because of the knowledge of the developer and a trusted status.

FIG. 7 illustrates an exemplary routine 700 for determining an application access level. The routine 700 begins at operation 702, where the identity of the application developer of the selected application is retrieved. Various technologies may be used to retrieve the identity of the application developer. For example, the identity of the application developer may be included in a certificate provided with the application. In another configuration, the identity of the application developer may be provided by way of query to a central data store. In another configuration, the identity of the application developer may be provided in a pre-approved list. The concepts and technologies described herein are not limited to any particular manner in which the identity of the developer of an application is determined. From operation 702, the routine 700 proceeds to operation 704, where the system resource access level of the developer is determined. As described above, applications from certain developers may be integrated into the software product 106 and may have various system resource access levels designated. From operation 704, the routine 600 proceeds to operation 706, where the application is integrated at the access level determined in operation 704. From operation 706, the routine 700 ends.

FIG. 8 shows an illustrative computer architecture 800 for a device capable of executing the software components described herein. Thus, the computer architecture 800 illustrated in FIG. 8 illustrates an architecture for a server computer, mobile phone, a smartphone, a desktop computer, a netbook computer, a tablet computer, and/or a laptop computer. The computer architecture 800 may be utilized to execute any aspects of the software components presented herein.

The computer architecture 800 illustrated in FIG. 8 includes a central processing unit (“CPU”) 802, a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing the operating system 104 from FIG. 1A and one or more application programs including, but not limited to, the software product 106 and the application searcher 116.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 800. For purposes of the claims, the phrase “computer storage medium,” and variations thereof, does not include waves or signals per se and/or communication media.

According to various embodiments, the computer architecture 800 may operate in a networked environment using logical connections to remote computers through a network such as the network 102. The computer architecture 800 may connect to the network 102 through a network interface unit 816 connected to the bus 810. It should be appreciated that the network interface unit 816 also may be utilized to connect to other types of networks and remote computer systems. The computer architecture 800 also may include an input/output controller 818 for receiving and processing input from a number of other devices, including a keyboard, mouse, or electronic stylus. Similarly, the input/output controller 818 may provide an output to a display screen, a printer, or other type of output device.

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this description.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

FIG. 9 shows an illustrative distributed computing environment 900 capable of executing the software components described herein for providing the concepts and technologies described herein. Thus, the distributed computing environment 900 illustrated in FIG. 9 may be utilized to execute any aspects of the software components presented herein and to provide the functionality described herein.

According to various implementations, the distributed computing environment 900 includes a computing environment 902 operating on, in communication with, or as part of the network 102. The network 102 also can include various access networks. One or more client devices 906A-906N (hereinafter referred to collectively and/or generically as “clients 906”) can communicate with the computing environment 902 via the network 102 and/or other connections (not illustrated in FIG. 9). In the illustrated embodiment, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. It should be understood that the illustrated clients 906 and computing architectures illustrated and described herein are illustrative, and should not be construed as being limited in any way.

In the illustrated embodiment, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated embodiment, the application servers 908 host one or more virtual machines 914 for hosting applications or other functionality. According to various implementations, the virtual machines 914 host one or more applications and/or software modules for providing the functionality described herein. It should be understood that this embodiment is illustrative, and should not be construed as being limiting in any way. The application servers 908 also host or provide access to one or more Web portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also can include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 922 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above embodiments are illustrative, and should not be construed as being limited in any way.

As shown in FIG. 9, the application servers 908 also can host other services, applications, portals, and/or other resources (“other resources”) 924. The other resources 924 can include, but are not limited to, the software product 106, the application searcher 116, and/or the application integrator 112. It thus can be appreciated that the computing environment 902 can provide integration of the concepts and technologies disclosed herein with various mailbox, messaging, social networking, and/or other services or resources. For example, the concepts and technologies disclosed herein can integrated social networking information into various searches and provide those results to a user in conjunction with internal knowledge.

As mentioned above, the computing environment 902 can include data storage 910. According to various implementations, the functionality of the data storage 910 is provided by one or more databases operating on, or in communication with, the network 102. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store the local application data store 122 shown in FIG. 1A.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 900 to utilize the functionality described herein for providing an integrated software product-application platform.

Turning now to FIG. 10, an illustrative computing device architecture 1000 for a computing device that is capable of executing various software components is described herein for providing an integrated software product-application platform. The computing device architecture 1000 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 1000 is applicable to any of the clients 906 shown in FIG. 9. Furthermore, aspects of the computing device architecture 1000 may be applicable to traditional desktop computers, portable computers (e.g., laptops, notebooks, ultra-portables, and netbooks), server computers, and other computer systems, such as described herein with reference to FIG. 1A. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output (“I/O”) components 1010, and power components 1012. In the illustrated embodiment, the processor 1002 is in communication with the memory components 1004, the network connectivity components 1006, the sensor components 1008, the I/O components 1010, and the power components 1012. Although no connections are shown between the individuals components illustrated in FIG. 10, the components can interact to carry out device functions. In some embodiments, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some embodiments, the processor 1002 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some embodiments, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some embodiments, the processor 1002 is fabricated, in part, utilizing a package-on-package (“PoP”) integrated circuit packaging technique. Moreover, the processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, Calif. and others. In some embodiments, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some embodiments, the RAM 1014 or a portion thereof, the ROM 1016 or a portion thereof, and/or some combination the RAM 1014 and the ROM 1016 is integrated in the processor 1002. In some embodiments, the ROM 1016 is configured to store a firmware, an operating system or a portion thereof (e.g., operating system kernel), and/or a bootloader to load an operating system kernel from the integrated storage 1018 or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some embodiments, the removable storage 1020 is provided in lieu of the integrated storage 1018. In other embodiments, the removable storage 1020 is provided as additional optional storage. In some embodiments, the removable storage 1020 is logically combined with the integrated storage 1018 such that the total available storage is made available and shown to a user as a total combined capacity of the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various embodiments, the operating system includes, but is not limited to, SYMBIAN OS from SYMBIAN LIMITED, WINDOWS MOBILE OS from MICROSOFT CORPORATION of Redmond, Wash., WINDOWS PHONE OS from MICROSOFT CORPORATION, WINDOWS from MICROSOFT CORPORATION, PALM WEBOS from HEWLETT-PACKARD COMPANY of Palo Alto, Calif., BLACKBERRY OS from BLACKBERRY of Waterloo, Ontario, Canada, IOS from APPLE INC. of Cupertino, Calif., and ANDROID OS from GOOGLE INC. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 102, which may be a WWAN, a WLAN, or a WPAN. Although a single network 102 is illustrated, the network connectivity components 1006 may facilitate simultaneous communication with multiple networks. For example, the network connectivity components 1006 may facilitate simultaneous communications with multiple networks via one or more of a WWAN, a WLAN, or a WPAN.

The network 102 may be a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 102 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 102 may be configured to provide voice and/or data communications with any combination of the above technologies. The network 102 may be configured to or adapted to provide voice and/or data communications in accordance with future generation technologies.

In some embodiments, the WWAN component 1022 is configured to provide dual-multi-mode connectivity to the network 102. For example, the WWAN component 1022 may be configured to provide connectivity to the network 102, wherein the network 102 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 102 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1024 is configured to connect to the network 102 via the WI-FI access points. Such connections may be secured via various encryption technologies including, but not limited, WI-FI Protected Access (“WPA”), WPA2, Wired Equivalent Privacy (“WEP”), and the like.

The network 102 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1026 is configured to facilitate communications with other devices, such as peripherals, computers, or other computing devices via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also may be incorporated in the computing device architecture 1000.

The magnetometer 1028 is configured to measure the strength and direction of a magnetic field. In some embodiments the magnetometer 1028 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1028 are contemplated.

The ambient light sensor 1030 is configured to measure ambient light. In some embodiments, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some embodiments, the proximity sensor 1032 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1032 are contemplated.

The accelerometer 1034 is configured to measure proper acceleration. In some embodiments, output from the accelerometer 1034 is used by an application program as an input mechanism to control some functionality of the application program. For example, the application program may be a video game in which a character, a portion thereof, or an object is moved or otherwise manipulated in response to input received via the accelerometer 1034. In some embodiments, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some embodiments, output from the gyroscope 1036 is used by an application program as an input mechanism to control some functionality of the application program. For example, the gyroscope 1036 can be used for accurate recognition of movement within a 3D data environment of a video game application or some other application. In some embodiments, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 may be used by any application program that requires or benefits from location information. For example, the location calculated by the GPS sensor 1038 may be used with a navigation application program to provide directions from the location to a destination or directions from the destination to the location. Moreover, the GPS sensor 1038 may be used to provide location information to an external location-based service, such as E911 service. The GPS sensor 1038 may obtain location information generated via WI-FI, WIMAX, and/or cellular triangulation techniques utilizing one or more of the network connectivity components 1006 to aid the GPS sensor 1038 in obtaining a location fix. The GPS sensor 1038 may also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some embodiments, the display 1040 and the touchscreen 1042 are combined. In some embodiments two or more of the data I/O component 1044, the audio I/O interface component 1046, and the video I/O component 1048 are combined. The I/O components 1010 may include discrete processors configured to support the various interface described below, or may include processing functionality built-in to the processor 1002.

The display 1040 is an output device configured to present information in a visual form. In particular, the display 1040 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 1040 is a liquid crystal display (“LCD”) utilizing any active or passive matrix technology and any backlighting technology (if used). In some embodiments, the display 1040 is an organic light emitting diode (“OLED”) display. Other display types are contemplated.

The touchscreen 1042 is an input device configured to detect the presence and location of a touch. The touchscreen 1042 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1042 is incorporated on top of the display 1040 as a transparent layer to enable a user to use one or more touches to interact with objects or other information presented on the display 1040. In other embodiments, the touchscreen 1042 is a touch pad incorporated on a surface of the computing device that does not include the display 1040. For example, the computing device may have a touchscreen incorporated on top of the display 1040 and a touch pad on a surface opposite the display 1040.

In some embodiments, the touchscreen 1042 is a single-touch touchscreen. In other embodiments, the touchscreen 1042 is a multi-touch touchscreen. In some embodiments, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1042. As such, a developer may create gestures that are specific to a particular application program.

In some embodiments, the touchscreen 1042 supports a tap gesture in which a user taps the touchscreen 1042 once on an item presented on the display 1040. The tap gesture may be used for various reasons including, but not limited to, opening or launching whatever the user taps. In some embodiments, the touchscreen 1042 supports a double tap gesture in which a user taps the touchscreen 1042 twice on an item presented on the display 1040. The double tap gesture may be used for various reasons including, but not limited to, zooming in or zooming out in stages. In some embodiments, the touchscreen 1042 supports a tap and hold gesture in which a user taps the touchscreen 1042 and maintains contact for at least a pre-defined time. The tap and hold gesture may be used for various reasons including, but not limited to, opening a context-specific menu.

In some embodiments, the touchscreen 1042 supports a pan gesture in which a user places a finger on the touchscreen 1042 and maintains contact with the touchscreen 1042 while moving the finger on the touchscreen 1042. The pan gesture may be used for various reasons including, but not limited to, moving through screens, images, or menus at a controlled rate. Multiple finger pan gestures are also contemplated. In some embodiments, the touchscreen 1042 supports a flick gesture in which a user swipes a finger in the direction the user wants the screen to move. The flick gesture may be used for various reasons including, but not limited to, scrolling horizontally or vertically through menus or pages. In some embodiments, the touchscreen 1042 supports a pinch and stretch gesture in which a user makes a pinching motion with two fingers (e.g., thumb and forefinger) on the touchscreen 1042 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some embodiments, the data I/O interface component 1044 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1046 is configured to provide audio input and/or output capabilities to the computing device. In some embodiments, the audio I/O interface component 1044 includes a microphone configured to collect audio signals. In some embodiments, the audio I/O interface component 1044 includes a headphone jack configured to provide connectivity for headphones or other external speakers. In some embodiments, the audio I/O interface component 1046 includes a speaker for the output of audio signals. In some embodiments, the audio I/O interface component 1044 includes an optical audio cable out.

The video I/O interface component 1048 is configured to provide video input and/or output capabilities to the computing device. In some embodiments, the video I/O interface component 1048 includes a video connector configured to receive video as input from another device (e.g., a video media player such as a DVD or BLURAY player) or send video as output to another device (e.g., a monitor, a television, or some other external display). In some embodiments, the video I/O interface component 1048 includes a High-Definition Multimedia Interface (“HDMI”), mini-HDMI, micro-HDMI, DisplayPort, or proprietary connector to input/output video content. In some embodiments, the video I/O interface component 1048 or portions thereof is combined with the audio I/O interface component 1046 or portions thereof.

The camera 1050 can be configured to capture still images and/or video. The camera 1050 may utilize a charge coupled device (“CCD”) or a complementary metal oxide semiconductor (“CMOS”) image sensor to capture images. In some embodiments, the camera 1050 includes a flash to aid in taking pictures in low-light environments. Settings for the camera 1050 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1052, which can be connected to a battery gauge 1054. The batteries 1052 may be rechargeable or disposable. Rechargeable battery types include, but are not limited to, lithium polymer, lithium ion, nickel cadmium, and nickel metal hydride. Each of the batteries 1052 may be made of one or more cells.

The battery gauge 1054 can be configured to measure battery parameters such as current, voltage, and temperature. In some embodiments, the battery gauge 1054 is configured to measure the effect of a battery's discharge rate, temperature, age and other factors to predict remaining life within a certain percentage of error. In some embodiments, the battery gauge 1054 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1012 may also include a power connector, which may be combined with one or more of the aforementioned I/O components 1010. The power components 1012 may interface with an external power system or charging equipment via a power I/O component (not illustrated).

Based on the foregoing, it should be appreciated that concepts and technologies for providing an integrated software product-application platform have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

1. A method for creating a custom software product, the method comprising:
receiving an input to modify features of a software product to perform custom features;
determining if the features are modifiable;
if the features are modifiable, permitting the search of an application store by invoking a search user interface to receive a search criteria;
receiving the search criteria;
accessing an application data store;
searching the application data store for applications that perform the custom features using the search criteria;
receive one or more search results of the search comprising the applications;
receiving a selection of one of the applications as a selected application to integrate into the software product;
receiving the selected application from the application data store; and
integrating the selected application into the software product to create the custom software product.

2. The method of claim 1, further comprising associating a custom brand with the custom software product.

3. The method of claim 1, further comprising providing a set of custom templates.

4. The method of claim 1, wherein the selected application comprises custom help associated with the custom features of the selected application.

5. The method of claim 1, further comprising associating metadata with an output of the custom software product that indicates a different user experience when the output is used with the software product rather than the custom software product.

6. (canceled)

7. The method of claim 1, wherein the application data store comprises a zero party application store, a third party application store or a local application data store.

8. The method of claim 1, wherein integrating the selected application into the software product comprises determining a system resource access level of the selected application.

9. The method of claim 8, wherein determining a system resource access level of the selected application comprises determining a permission level of the selected application.

10. The method of claim 9, wherein determining permission level of the selected application comprises receiving a certificate with the selected application, searching for an identity of a developer of the selected application, or checking the identity of the developer of the selected application against a pre-approved list.

11. A computer, comprising:
a processor; and
a computer-readable storage medium in communication with the processor, the computer-readable storage medium comprising computer-executable instructions stored thereupon which, when executed by the processor, cause the processor to
receive an input to integrate a feature into a software product;
determine if the feature is in a feature list;
if the feature is in a feature list, determine if the feature is modifiable;
if the feature is modifiable, invoke a search user interface;
receive a search criteria;
access an application store;
search the application store for an application that performs the feature; using the search criteria;
receive one or more results of the search comprising one or more applications;
receive a selection of the one or more applications as a selected application to integrate into the software product;
retrieve the application from the application store; and
integrate the application into the software product to provide the feature.

12. The computer of claim 11, wherein the computer-executable instructions which, when executed by the processor, cause the processor to receive the input to integrate the feature into the software product comprises computer-executable instructions to invoke an application searcher.

13. The computer of claim 12, wherein the computer-executable instructions which, when executed by the processor, cause the processor to invoke the application searcher comprises computer-executable instructions to receive an input to an application searcher input button of the software product.

14. The computer of claim 11, wherein the computer-executable instructions which, when executed by the processor, cause the processor to search for one or more applications comprises computer-executable instructions to initiate a feature search selection user interface or a feature search user interface.

15. The computer of claim 14, wherein the feature search selection user interface comprises a display of modifiable features of the plurality of features.

16. The computer of claim 14, wherein the feature search user interface comprises a search input for receiving search criteria.

17. The computer of claim 11, wherein the computer-executable instructions which, when executed by the processor, cause the processor to integrate the selected application into the software product to provide the feature comprises computer-executable instructions to determine a permission level of the selected application.

18. The computer of claim 17, wherein the permission level is unrestricted to a system resource if the selected application is a zero party application.

19. A computer-readable storage medium comprising computer-executable instructions stored thereupon which, when executed by a computer, cause the computer to:
receive an input to invoke an application searcher for a feature of a plurality of features of a software product,
determine if the feature of the plurality of features is in a feature list,
if the feature of the plurality of features is in the feature list, determine if the feature of the plurality of features is modifiable,
if the feature of the plurality of features is modifiable, invoke a search user interface,
receive a search criteria,
search an application store using the search criteria,
receive one or more results of the search comprising one or more applications,
receive a selection of the one or more applications as a selected application to integrate into the software product, and
integrate the selected application into the software product.

20. The computer-readable storage medium of claim 17, wherein the instructions to integrate the selected application into the software product further comprises instructions to determine a system resource access level of the selected app, wherein the instructions to determine the system resource access level of the selected application comprises instructions to determine the identity of the developer of the selected app.
